(19) United States
(12) Patent Application Publication
(10) Pub. No.: US 2019/0285414 A1
(43) Pub. Date: Sep. 19, 2019

(54) Laser Alignment Guide

(71) Applicant: Paul Joseph Doeren, St . Charles, MO (US)

(72) Inventor: Paul Joseph Doeren, St . Charles, MO (US)

(21) Appl. No.: 16/297,909

(22) Filed: Mar. 11, 2019

Related U.S. Application Data
(63) Continuation-in-part of application No. 29/680,065, filed on Feb. 13, 2019.
Application No. 29/680,065 is a continuation-in-part of application No. 15/603,610, filed on May 24, 2017, now Pat. No. 10,309,776.
(60) Provisional application No. 62/340,592, filed on May 24, 2016.

(51) Int. Cl. G01C 15/00; G01C 9/34

(52) U.S. Cl. CPC G01C 15/004; G01C 9/34; G01C 15/008

(57) ABSTRACT

A laser alignment guide. The laser alignment guide includes a housing having at least one sidewall and a base defining an interior volume therein. A cap is removably securable to an upper end of the housing. The cap further includes at least one light source that can emit a visible laser disposed thereon. A mounting bracket that can magnetically secure to a surface is disposed on a second end of the housing. In some embodiments, at least one light source is disposed on a sidewall of the housing.

### CROSS REFERENCE TO RELATED APPLICATIONS

This application claims the benefit of U.S. Patent Application No. 29/680,065, filed on Feb. 13, 2019, which claims the benefit of U.S. patent application Ser. No. 15/603,610, filed on May 24, 2017, which claims the benefit of U.S. Provisional Application No. 62/340,592 filed on May 24, 2016. The above identified patent application is herein incorporated by reference in its entirety to provide continuity of disclosure.

### BACKGROUND OF THE INVENTION

The present invention relates to laser alignment guides. Specifically, it relates to laser alignment guides that removably secures to a surface.

Many electricians and construction workers must determine the proper alignment and orientation for conduits to be installed. Traditionally, an offset bend is used to match the geometry of closely positioned objects without contacting a part of a structure or to bring a conduit out from the structure. Using this method, determining the angle of the bend in an offset can be time consuming and is frequently inaccurate. This leads to many wasted man hours and expense in trying to find the precise measurement.

There is currently no device on the market that will enable an electrician to accurately measure the distances between the end of the last piece of conduit placed and the next when placing conduits. Further, there is no device that will enable an electrician to make this measurement from the ground. Many times, one must climb up and down a ladder several times and make many adjustments before being able to correctly place the conduit. Therefore, a device that can assist with the precise alignment of conduits is needed.

In light of the devices disclosed in the known art, it is submitted that the present invention substantially diverges in design elements from the known art and consequently it is clear that there is a need in the art for an improvement to existing laser alignment guides. In this regard, the instant invention substantially fulfills these needs.

### SUMMARY OF THE INVENTION

In view of the foregoing disadvantages inherent n the known types of laser alignment guide now present in the prior art, the present invention provides a laser alignment guide wherein the same can be utilized for providing convenience for the user when aligning conduits to match the geometry of closely positioned objects.

The present system comprises a housing having at least one sidewall and a base defining an interior volume therein. A cap is removably securable to an upper end of the conduit and further comprises at least one light source configured to emit a visible laser disposed thereon. A mounting bracket is disposed on a second end of the housing and is configured to removably secure the housing to a surface via magnetic attraction. In some embodiments, the device further comprises an etching tool having a blade configured to score the surface. In another embodiment, the device further comprises a blade sharpener configured to sharpen the blade of the etching tool. In other embodiments, the interior volume is configured to store the etching tool and the blade sharpener. In yet another embodiment, the housing further comprises a horizontal bubble level disposed on the sidewall thereof. In some embodiments, the sidewall further comprises a vertical bubble level disposed thereon. In another embodiment, the cap further comprises a vertical bubble level disposed thereon. In other embodiments, the device further comprises an activation switch disposed on the cap wherein the activation switch is in electrical communication with a power source and the light source. In yet another embodiment, the power source comprises a batter disposed within the interior volume of the housing. In some embodiments, the device further comprises a measuring tool configured to fit within the interior volume. In another embodiment, the measuring tool is telescopic. In other embodiments, the device further includes a reflective assembly configured to selectively reflect the laser emitted from the light source at various angles. In yet another embodiment, the reflective assembly selectively reflects the laser via rotation of the cap. In some embodiments, at least one light source is disposed on a sidewall of the housing.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the laser alignment guide.

FIG. 2A shows a perspective view of an embodiment of the interior volume of the laser alignment guide.

FIG. 2B shows a perspective view of an embodiment of the power source of the laser alignment guide.

FIG. 3A shows a perspective view of an embodiment of the etching tool of the laser alignment guide.

FIG. 3B shows a perspective view of an embodiment of the blade sharpener of the laser alignment guide.

FIG. 3C shows a perspective view of an embodiment of the measuring tool of the laser alignment guide.

FIG. 4 shows a perspective view of an embodiment of the laser alignment guide in use.

FIG. 5 shows a perspective view of an embodiment of the laser alignment guide where the device is compact and has multiple laser settings.

### DETAILED DESCRIPTION OF THE INVENTION

Reference is made herein to the attached drawings. Like reference numerals are used throughout the drawings to depict like or similar elements of the laser alignment guide. The figures are intended for representative purposes only and should not be considered to be limiting in any respect.

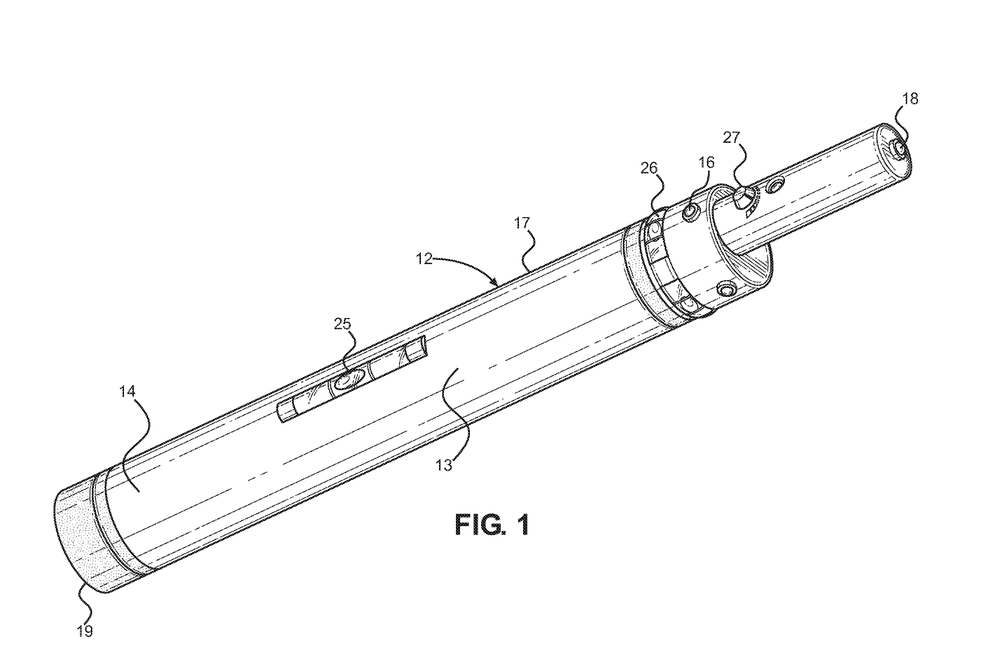

Referring now to FIG. 1, there is shown a perspective view of an embodiment of the laser alignment guide. The laser alignment guide 11 comprises a housing 12 having a base 14, an upper end 17, and at least one sidewall 13 defining an interior volume. In the illustrated embodiment, the housing 12 further comprises a horizontal bubble level 25 disposed on the sidewall 13. The horizontal bubble level 25 is configured to determine whether the laser alignment guide 11 is perpendicular to the force of gravity. In some embodiments, a vertical bubble level 26 is disposed on the sidewall 13, wherein the vertical bubble level 26 is configured to determine whether the laser alignment guide 11 is parallel to the force of gravity. In this way, a user can determine whether the laser alignment guide 11 is aligned whether the laser alignment guide 11 is in a horizontal or vertical position. In another embodiment, the housing 12 further comprises a clip configured to removably secure the housing to an obstruction, such as a floor joist.

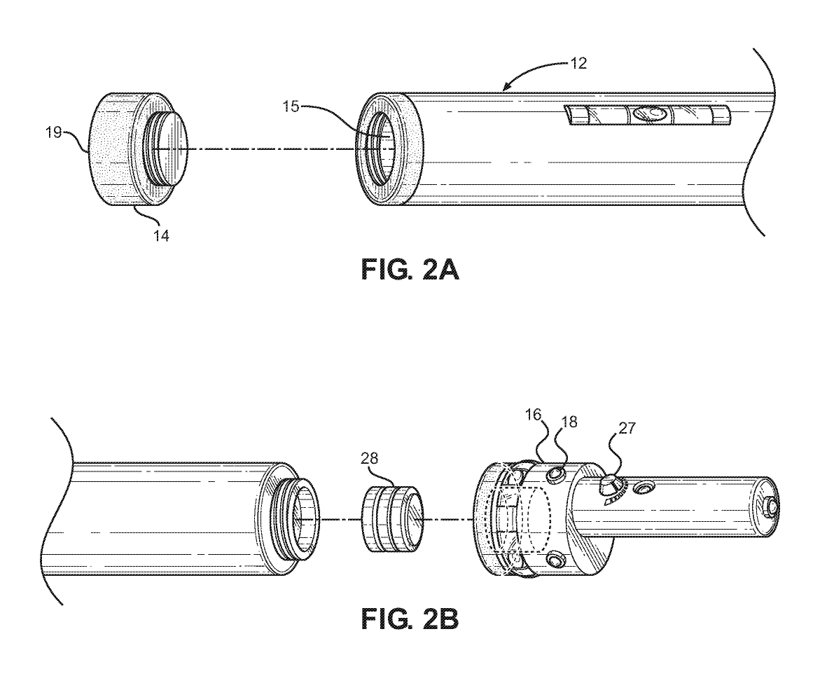

A cap 16 is disposed on the upper end 17 of the housing 12. The cap 16 is configured to removably secure to the upper end 17. In some embodiments, the upper end 17 further comprises external threading to engage with internal threading disposed on the cap 16 (seen in FIG. 2B). At least one light source 18 is disposed on the cap 16. In the illustrated embodiment, the cap 16 further comprises a vertical bubble level 26. The light source 18 is configured to emit a visible laser. In the illustrated embodiment, light sources 18 are distributed across an outer surface of the cap 16, such that multiple visible lasers are emitted at differing angles. In some embodiments, these light sources 18 are positioned such that the lasers emitted therefrom represent independent horizontal and vertical axes in three dimensions, representing the abscissa, ordinate, and applicate. In some embodiments, the cap 16 further comprises a reflective assembly configured to selectively reflect the lasers emitted from the light source 18 to a desired position. In other embodiments, the reflective assembly is configured to selectively reflect the lasers via rotation of the cap 16 perpendicular to the length of the housing 12.

The base 14 of the housing 12 is configured to removably secure to the housing 12. A mounting bracket 19 is disposed on the base 14 and is configured to engage with a surface. In the illustrated embodiment, the mounting bracket 19 is configured to removably secure to a surface via magnetic attraction. Additionally, the base 14 is configured to fit within various standard sizes of connectors for electrical metal tubing or conduit. In some embodiments, the laser alignment guide 11 further comprises a set of adaptors configured to removably secure to the base 14. The adaptors are dimensioned to fit within various standard sizes of conduit connectors, such that the laser alignment guide 11 can be removably secured within the connectors.

Referring now to FIG. 2A, there is shown a perspective view of an embodiment of the interior volume of the laser alignment guide. In the illustrated embodiment, the base is configured to engage with the housing 12 via internal threads of the housing 12 and external threads of the base 14. Removing the base 14 exposes the interior volume 15. In some embodiments, the interior volume 15 is configured to store accessories therein. In other embodiments, a carrying case is included to store accessories therein.

Referring now to FIG. 2B, there is shown a perspective view of an embodiment of the power source of the laser alignment guide. The cap 16 further comprises an activation switch 27 in electrical communication with a power source 28 and the light source 18. In the illustrated embodiment, the activation switch 27 comprises a dial configured to vary the intensity of the laser emitted from the light source 18, however in other embodiments, it comprises a button, toggle switch, and the like. The power source 28 is configured to secure within the cap 16 and provide power to the laser alignment guide.

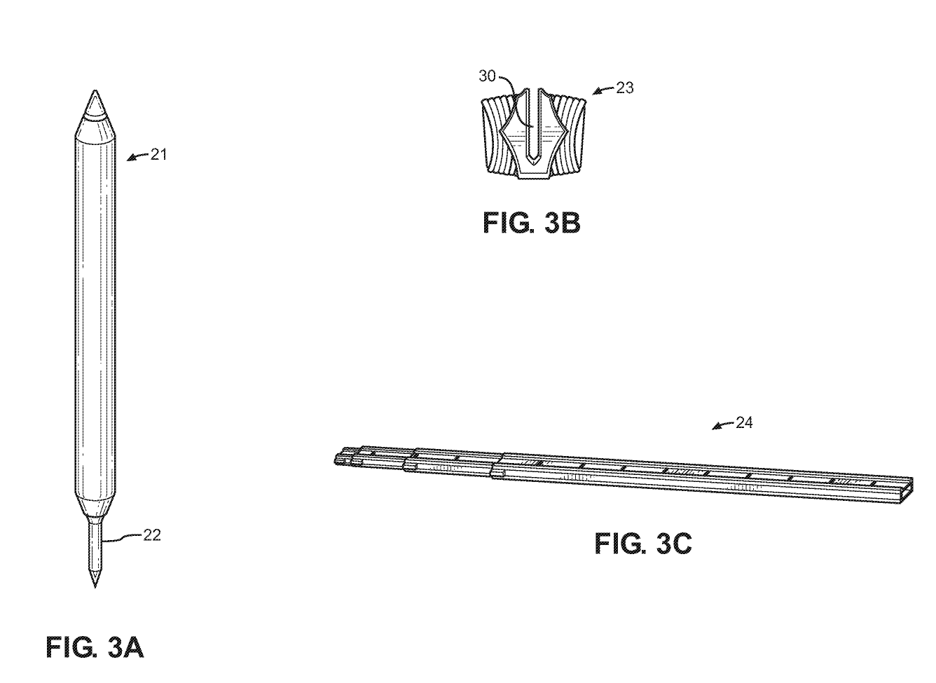

Referring now to FIGS. 3A, 3B, and 3C, there is shown a perspective view of an embodiment of the etching tool of the laser alignment guide, a perspective view of an embodiment of the blade sharpener of the laser alignment guide, and a perspective view of an embodiment of the measuring tool of the laser alignment guide, respectively. The laser alignment guide further comprises an etching tool 21 having a blade 22 disposed thereon. The blade 22 is configured to score face to indicate a desired distance or location measured using the laser alignment guide. In some embodiments, the laser alignment guide further comprises a blade sharpener 23 having a notch 30 configured to hone the blade 22 of the etching tool 21 therein. In some embodiments, the etching tool 21 and blade sharpener 23 are configured to store within the interior volume. In another embodiment, the laser alignment guide further comprises a measuring tool 24 configured to fit within the interior volume. The measuring tool 24 comprises indicia at regular set lengths and is used to determine distance from the laser emitted from the laser alignment guide for conduit installation. In some embodiments, the measuring tool 24 is configured to be telescopic to allow efficient storage within the interior volume.

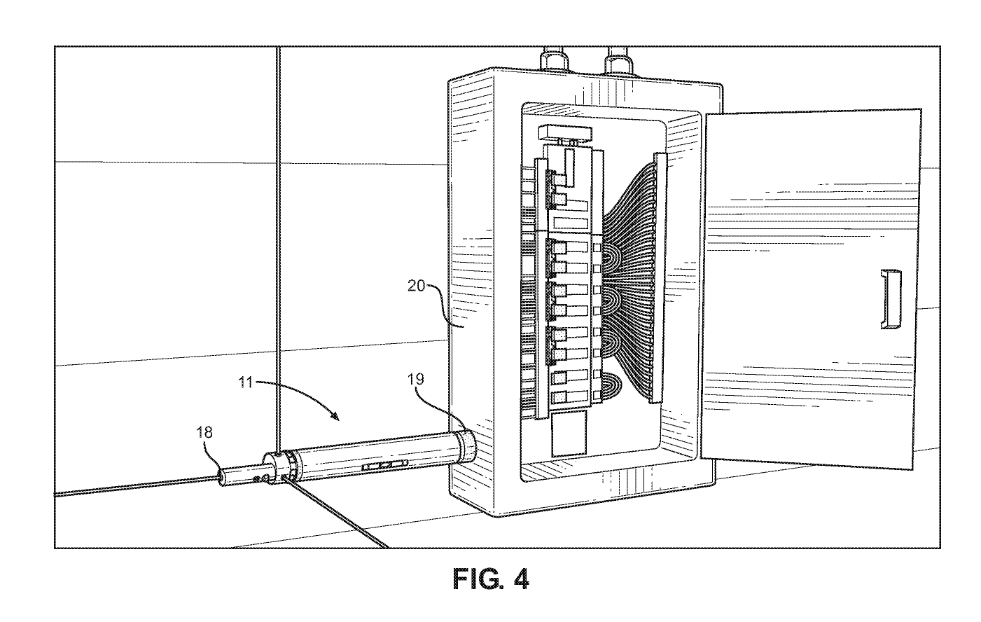

Referring now to FIG. 4, there is shown a perspective view of an embodiment of the laser alignment guide in use. In the illustrated embodiment, the laser alignment guide 11 is removably affixed to a surface 20 via the mounting bracket 19. The laser alignment guide 11 is further secured by fitting within an electrical r petal tubing connector disposed on the surface 20. In the illustrated embodiment, the surface 20 is an outer wall of an electrical box, however any surface 20 that requires electrical metal tubing connections is appropriate, such as junction boxes, fuse boxes, or electric water heaters.

In one use, a user needing to install electrical conduit, such as electrical metal tubing, removably affixes the laser alignment guide 11 to the surface 20 of the source of the conduit. The base 14 is inserted into an electrical metal tubing connector and secured to the surface via magnetic attraction by the mounting bracket 19. In some embodiments, the user can place an adaptor over the base 14 in order to effectively increase the width of the base 14 such that it can removably secure within larger electrical metal tubing connectors. Adjustments are then made to the alignment of the laser alignment guide 11 by consulting either the horizontal bubble level 25 or the vertical bubble level 26 to ensure the laser alignment guide 11 is level. The user activates the light source 18 via the activation switch 27, such that a laser is emitted from the cap 16. The laser indicates a straight line from the surface 20. In some embodiments, the user makes use of the included measuring tool 24 to measure distances from the laser to determine the appropriate bend needed in the conduit to create an offset. In this way, a user can accurately measure the bend required to navigate the conduit around obstacles with minimal effort. In some embodiments, the surface adjacent to the laser can be marked using the blade 22 of the etching tool 21 in order to indicate measured points along the trajectory, such as to indicate where the offset begins, or where a fastener is needed to support the conduit.

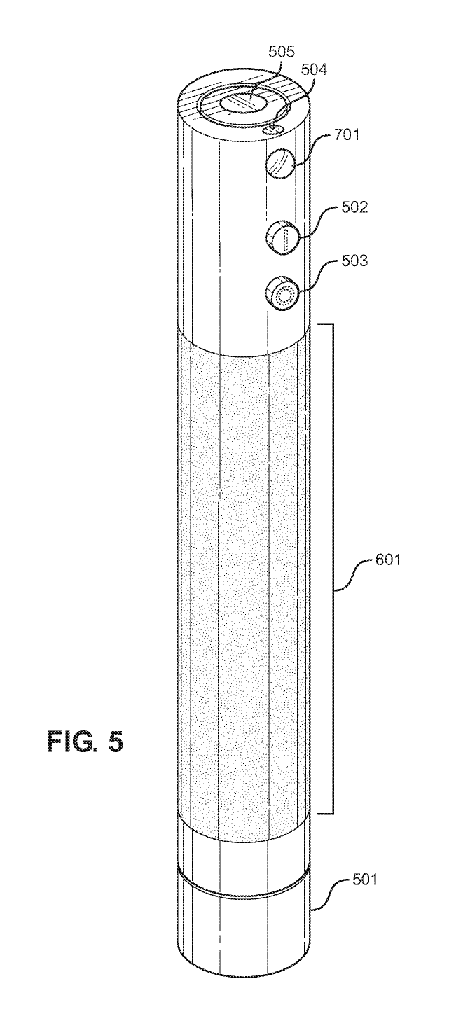

Referring to FIG. 5, there is shown an embodiment of the compact laser alignment guide tool for installing conduit. In this embodiment there is a base cap 501 disposed on one end of the tool. The base cap 501 is able to be removed to allow for a battery to be placed therein. In one embodiment, the battery may be a AAA, which will ensure that the device has ample power for the various light sources. In a second embodiment, the power source comprises one or more watch batteries, which will allow the device to be more compact. In one embodiment, the cap 501 is configured to form a water tight seal when secured to the housing. This seal may be created using a rubber washer. In another embodiment, the cap also includes a magnet disposed therein. This magnet will allow a user to place the device on a magnetic surface and have the device remain in place without being held.

The device has a top side including a laser 504. In the illustrated embodiment, the laser 504 is located on the edge of the top side of the device. This will allow a user to get an accurate measurement and not have to subtract the distance between the edge of the device and the laser center. The laser may be of a single type. In one embodiment, the laser 504 is configured to emit light in a single dot pattern. In another embodiment, the laser 504 is configured to emit light in a pattern that produces a visible line. In yet another embodiment, the laser 504 is configured to emit light in a plurality of patterns, and includes a control configured to select between the individual patterns of emitted light. This allows a user to use the tool in multiple different manners.

The device further includes several buttons located on the side of the device. In one embodiment, the device includes a laser button 502 and a light button 503. In one embodiment, the buttons may be of a type that only remain on when held, which prevents the device from being left on accidentally. In a second embodiment, the buttons are configured to turn the desired light source on when pressed a first time and configured to turn the desired light source off when pressed again. This allows a user to place the device in a location and not be constantly holding it while the device operates.

The laser button 502 may have several functions. In one embodiment the laser button 502 may only turn the laser 504 on and off. In a second, embodiment the laser button 502 may turn the laser on and off and switch between laser modes. This will keep the device simple and still allow a user to use multiple different laser modes. The light button 503 will enable the user to turn the flashlight on and off.

There is shown a side view of the device with a knife sharpener. The knife sharpener 601 may be a rough side of the device. In one embodiment, the knife sharpener 601 may be a grit sharpener similar to a file, which can sharpen a multitude of tools. In a second embodiment, the sharpener may be a diamond sharpener, which creates an effective edge on a knife. In both embodiments the sharpeners may rest flush with the edges of the tube and may not be raised above in order to provide a compact device.

Some embodiments of the laser alignment guide may include an electronic leveling system. This system can be incorporated into the device housing. This electronic leveling system may inform a user that the guide is level in a multitude of ways. In one embodiment, the electronic leveling system includes a light 701 attached to the housing of the guide. When the device is level, the light 701 illuminates to tell a user that the device is level. In a second embodiment, the guide includes a speaker that beeps when the device is level. In a further embodiment, the device can use both the light 701 and the beep in order to inform a user that the device is level.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A laser alignment guide tool, comprising:
a tubular body having a top end and a bottom end, wherein the tubular body defines an interior volume;
wherein the bottom end is removably secured to the tubular body;
a battery compartment disposed within the tubular body that is configured to be accessible when the bottom end is removed;
a laser button and a light button placed on a side of the tubular body;
the laser button operably coupled to a power supply and a laser;
the light button operably coupled to the power supply and a light;
wherein the laser is placed within the tubular body such that a laser pattern is emitted though the top end of the tubular body, wherein the laser pattern is emitted on an edge of the top side of the device;
wherein the light is placed on the top end of the device.

2) The laser alignment guide tool of claim 1, further comprising: a knife sharpener disposed thereon.

3) The laser alignment guide tool of claim 1, further comprising: an electronic level system.

4) The laser alignment guide tool of claim 3, further comprising: a light operably coupled to the electronic level system, wherein the light illuminates when the tool is level.

5) The laser alignment guide tool of claim 3, further comprising: a speaker operably coupled to the electronic level system, wherein the speaker emits a tone when the tool is level.

6) The laser alignment guide tool of claim 1, further comprising: a magnet disposed in the bottom end of the tool.

7) The laser alignment guide tool of claim 1, further comprising: waterproof seals disposed on the removable bottom end of the tool such that the bottom end is configured to form a waterproof seal between the bottom end and the tubular body when the bottom end is secured to the tubular body.
